(19) United States
(12) Patent Application Publication
(10) Pub. No.: US 2012/0147386 A1
(43) Pub. Date: Jun. 14, 2012

(54) Touch Device with Light Frequency Sensor for Sensing Relative Position of Object to be Detected

(76) Inventors: CHIH-HSUAN LIAO, Kaohsiung City (TW); YU-HSIANG CHENG, Kaohsiung City (TW); CHENG-HSUAN WANG, Kaohsiung City (TW)

(21) Appl. No.: 13/115,994

(22) Filed: May 26, 2011

(30) Foreign Application Priority Data
Dec. 9, 2010 (TW) 099143084

(51) Int. Cl. G01B 11/14

(52) U.S. Cl. 356/623

(57) ABSTRACT

A touch device with light frequency sensor to sense the relative position of an object to be detected includes a work area, a light source, at least two light frequency sensors, and a position computation module. The light source is arranged toward the work area for providing light with predetermined frequency. The two light frequency sensors are arranged for respectively detecting the light frequency signals entered into the lens and the optical filter. The position computation module is linked with the two light frequency sensors for signal connection and detects characteristic data by means of trigonometry to determine the position of the object to be detected. As the light frequency sensor could simple detects the signal, the position computing module with a relative low-order computing is capable of processing the signal. That means the high-order processor of the prior art is unnecessary to be used to processing the acquired image. Hence, the touch device of the present invention has a low cost while is capable of detecting the relative position of an object to be detected. Furthermore, only the light frequency sensor is used to acquire the light frequency to avoid the situation that when the image sensor of the prior art is acquiring images, the change of the environment light strength will cause the gray level hard to be determined or unable to be determined.

### BACKGROUND OF THE PRESENT INVENTION

1. Field of Invention

The present invention relates to a frequency signal acquiring apparatus of a touch device, and more particular to a device and method for sensing relative position of an object to be detected by means of a light frequency sensing module to acquire sensed light frequency signal as a computation base work area.

2. Description of Related Arts

Recently, more and more attention is paid to devices for determining the relative position of an object to be detected by means of acquiring an image optically. For example, in a big screen, image acquiring means is used to determine an image of a user's touch position, such as determining the user's touch position by acquiring image data of a finger of the user finger, a touch pen or other touch medium on the big screen.

The U.S. Pat. No. 7,236,162 discloses a conventional device, which mainly comprises an image sensor 11 directed toward a work area adapted to acquire image data of the user's touch position image in the work area. It is worth mentioning that, the image sensor 11 of the conventional technology is generally provided behind a lens 17 and comprises a pixel matrix composed of multiple linear pixel arrays 10, which is further connected to an image processing module 19. Referring to FIG. 2, the image sensor 11 is further connected with a quartz clock 12 for processing a function time sequence, wherein a frame buffer 13 is connected with a memory 14, and a programmable logic controller 15 is connected with a signal processor 16, wherein the signal processor 16 is connected with the memory 14. The signal processor 16 reads the data stored in the memory 14 to process the image data sensed by the image sensor 11.

Hence, the programmable logic controller 15 (CPLD) is utilized to process necessary function time sequences to further control the output of the image sensor 11 that acts as a buffer between the image sensor 11 and the frame buffer 13, and then the acquired image data is stored in the memory 14 which is connected to the frame buffer 13 for being read by the signal processor 16 (DSP).

In view of the prior art, the object of the image processing is generally to completely acquire the image, and thus the pixels are illuminated by the lights with different light intensities to respectively generate different electric currents, which are transformed to respectively generate different grey scales, as shown in FIG. 3, which further form a complete image acquiring base for determining the relative position. Therefore, a large amount of data must be acquired the multiple pixel matrix 10 composed of the complete and dense linear pixel arrays, which is further processed by complex computation to generate the signal information, so that the cost of the hardware greatly increases accordingly.

However, since such image sensing technology is merely used to determine the image position of the user's finger, touch pen or other touch medium on the big screen, there is no need to utilize such complex computation with higher cost. Hence, there is a need to provide an image sensor with a simplified data computation in lower cost.

Besides, the conventional computation is based on the determined grey scales of pixels of the linear pixel arrays, so that when the work condition is interfered by another light source, the device based on this conventional technology is not that applicable or might increase its signal mis-determination rate, which will be further increased along with the decrease of the pixel arrays.

### SUMMARY OF THE PRESENT INVENTION

In view of the above shortcomings, an improved system is desired that the present invention provides a touch device with light frequency sensor to sense the relative position of an object to be detected, which comprises:

a work area;

a light source arranged toward the work area for providing light with predetermined frequency;

at least two light frequency sensors for respectively detecting the light frequency signals entered into the lens and the optical filter; and

a position computation module, which is linked with the at least two light frequency sensors for signal connection and detects characteristic data by means of trigonometry to determine the position of the object to be detected.

The touch device of the present invention mainly comprises a first light frequency sensor and a second light frequency sensor for detecting light frequency signal. As the relative position is determined based on the existence and the nonexistence of the generated signals, and mainly based on the frequency of the light signals, multiple single light detector modules are assembled to receive, translate and analyze the light source signal on a specific position, and thus there is no need to generate an image. Therefore, a position computing module with a relative low-order computing is capable of processing the signal. That means the high-order processor of the prior art is unnecessary to be used to processing the acquired image. Hence, the touch device of the present invention has a low cost while is capable of detecting the relative position of an object to be detected. Furthermore, only the light frequency sensor is used to acquire the light frequency to avoid the situation that when the image sensor of the prior art is acquiring images, the change of the environment light strength will occur misinterpretation. Therefore, the environment light source of the touch device of the present invention is less limited.

### BRIEF DESCRIPTION OF THE DRAWINGS

FIG. 1 is a schematic view of a conventional image sensor.

FIG. 2 is a block diagram illustrating the conventional image sensor device.

FIG. 3 is a schematic diagram illustrating the position determining of the prior art.

FIG. 4 is a structural diagram of the single light detector module according to the above preferred embodiment of the present invention.

FIG. 5 is a schematic diagram illustrating the position determining of the present invention.

FIG. 6 is a schematic view of a light frequency sensor composed of multiple single light detector modules according to the above preferred embodiment of the present invention.

FIG. 7 is a structural diagram of the assembled single light detector modules according to the above preferred embodiment of the present invention.

FIG. 8 illustrates the signal acquiring of the electric circuit, which has received the light frequency.

FIG. 9 is a schematic view of the touch device with the light frequency sensor for sensing relative position of an object to be detected according to the above preferred embodiment of the present invention.

FIG. 10 is a flow chart of the present invention.

FIG. 11 is a curve chart illustrating the gain effect of the filter according to the present invention.

FIG. 12 illustrates the effect of the active signal determine with a light source with a specific frequency according to the present invention.

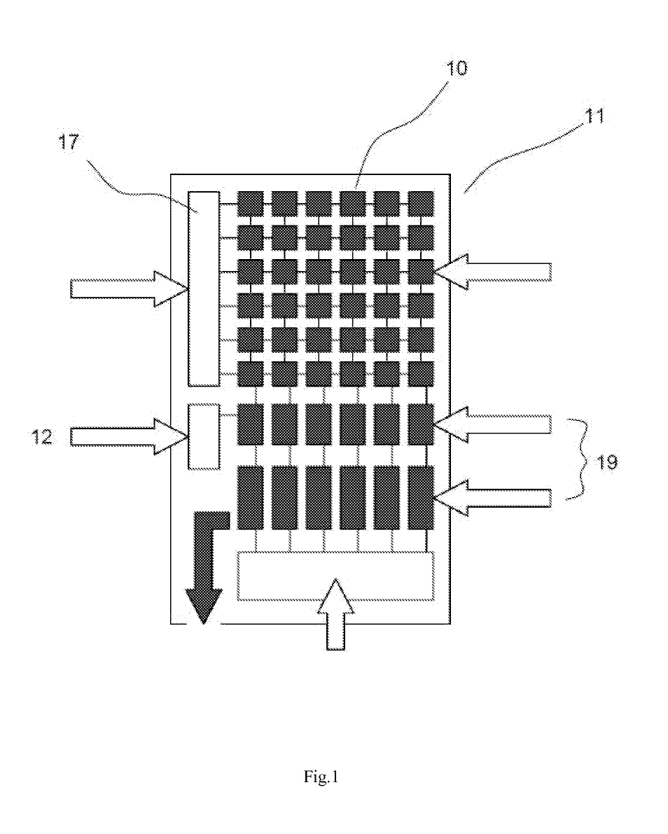

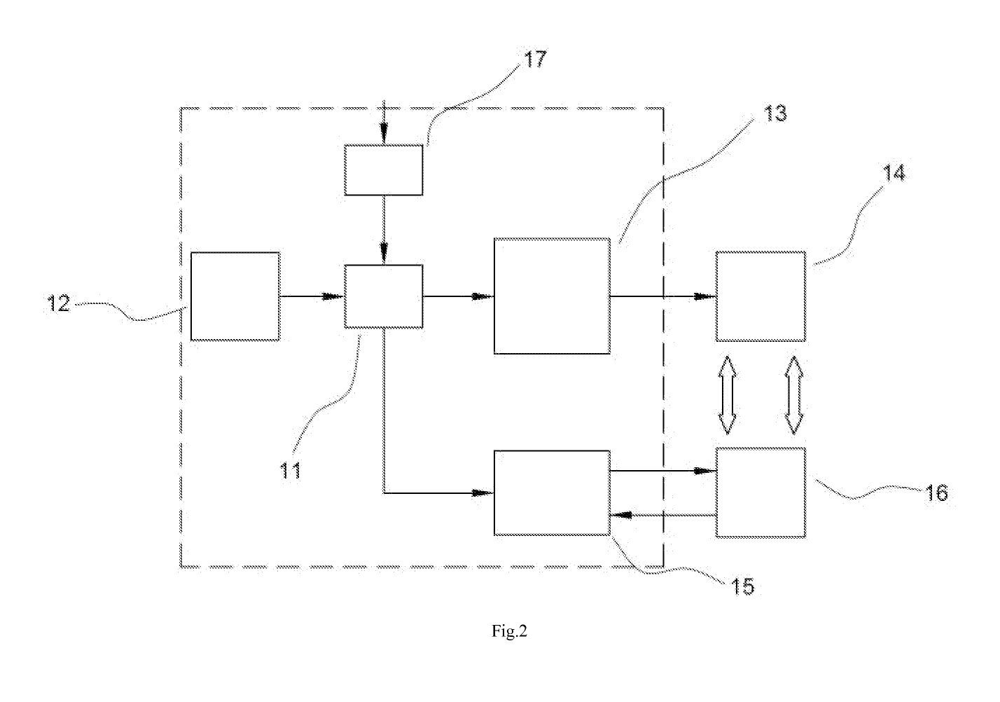

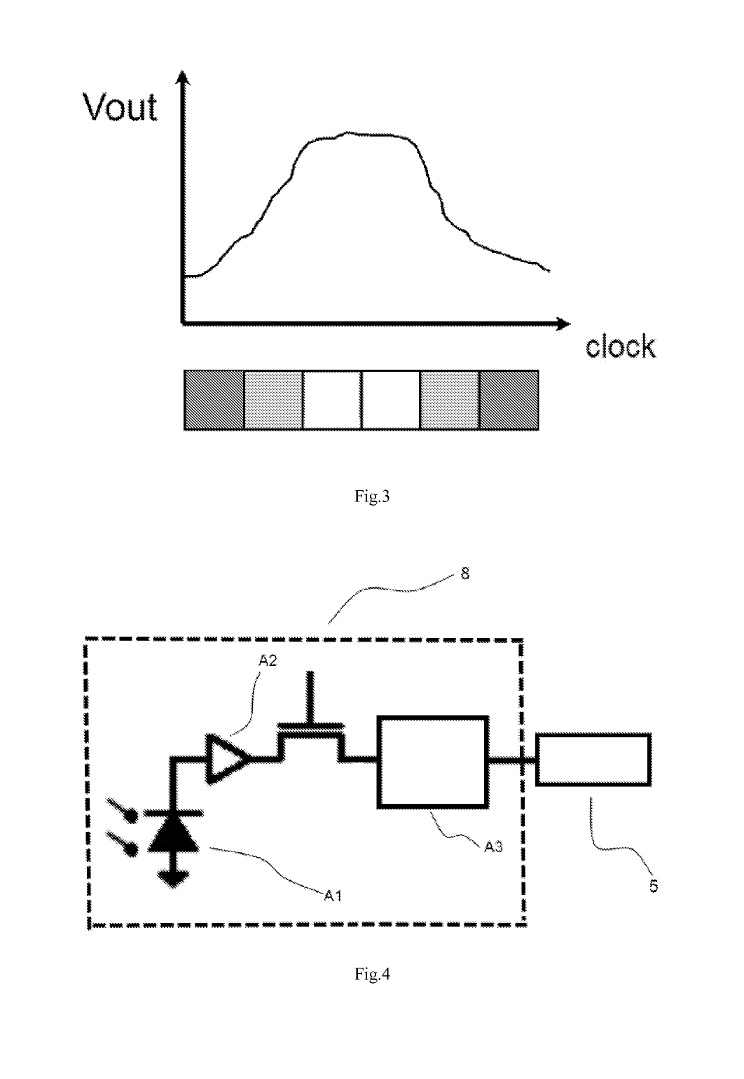

### DETAILED DESCRIPTION OF THE PREFERRED EMBODIMENT

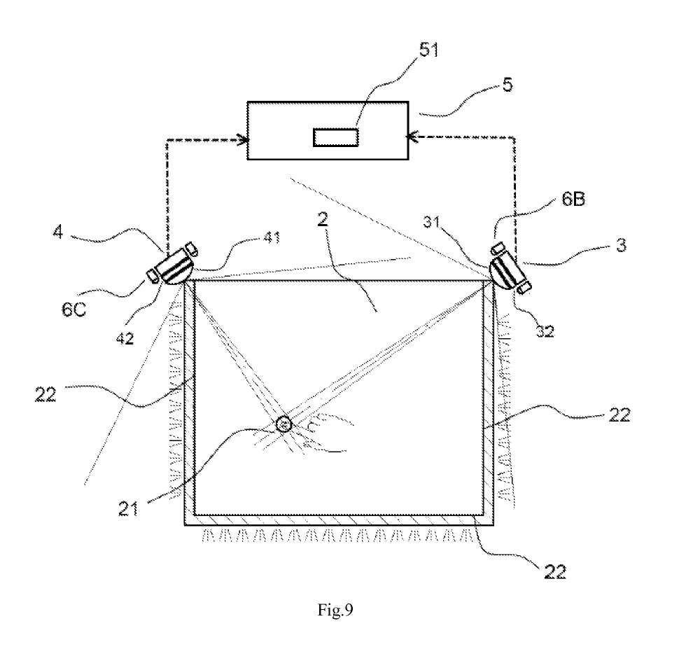

Referring to FIG. 9, a touch device with a light frequency sensor for sensing relative position of an object to be detected according to a preferred embodiment of the present invention is illustrated. The touch device comprises a work area 2, a first light frequency sensor 3, a second light frequency sensor 4, a set of reflecting sheets 22, and a position computation module 5.

Referring to FIG. 9, the work area 2 has a shape of quadrangle. The first light frequency sensor 3 and the second light frequency sensor 4 are aligned and respectively arranged at two angle corners of the work area 21 while directly toward the work area 2. The set of reflecting sheets 22 is disposed on the inside edges of the other three sides thereof, except for the side with the first light frequency sensor 3 and the second light frequency sensor 4 aligned thereon, wherein the reflecting sheets reflect the light source signal which is not provided for determining the position out off the work area 2, so as to avoid the unnecessary disturbance source.

Each of the first light frequency sensor 3 and the second light frequency sensor 4 comprises a light source 6B, 6C, which is arranged toward the work area 2 for arranging light inside the work area.

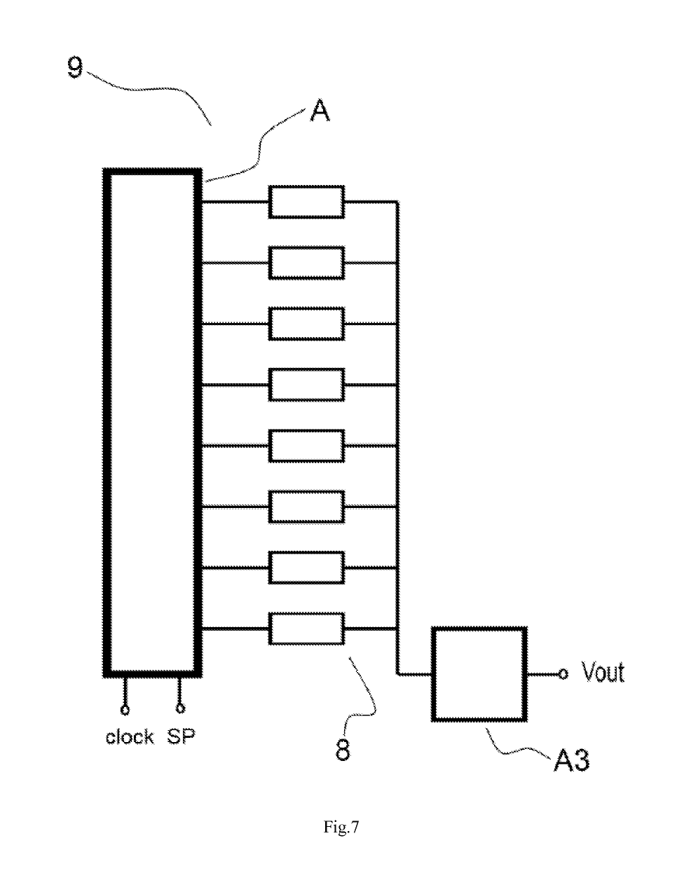

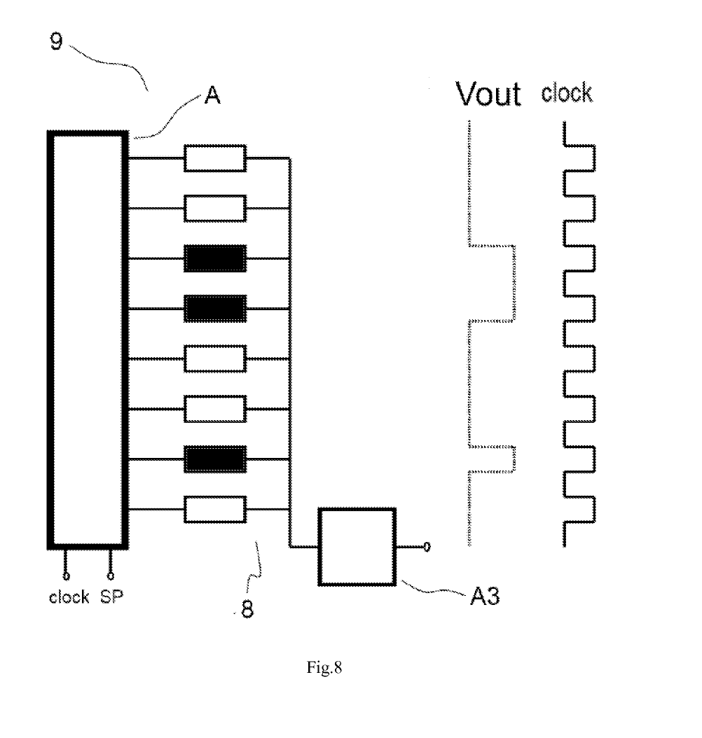

The first light frequency sensor 3 and the second light frequency sensor 4 respectively detects the light frequency of the lights entered into the lens 31, the filter 32 and the lens 41, filter 42. The first light frequency sensor 3 and the second light frequency sensor 4 are aligned and respectively arranged at two angle corners of the work area 21 while directly toward the work area 2. Each of the first light frequency sensor 3 and the second light frequency sensor 4 comprises a light receiving and scanning circuit module A as shown in FIG. 7, wherein the light receiving and scanning circuit module A comprises a filter A3 and the relative position is determined based on the existence and the nonexistence of the signals generated in the filter A3.

The position computation module 5 is linked with the at least two light frequency sensors for signal connection and has a position computation program 51 installed therein for computing the signals scanned and acquired in the light receiving and scanning modules A of the first light frequency sensor 3 and the second light frequency sensor 4 to accurately determine the relative position of the object to be detected.

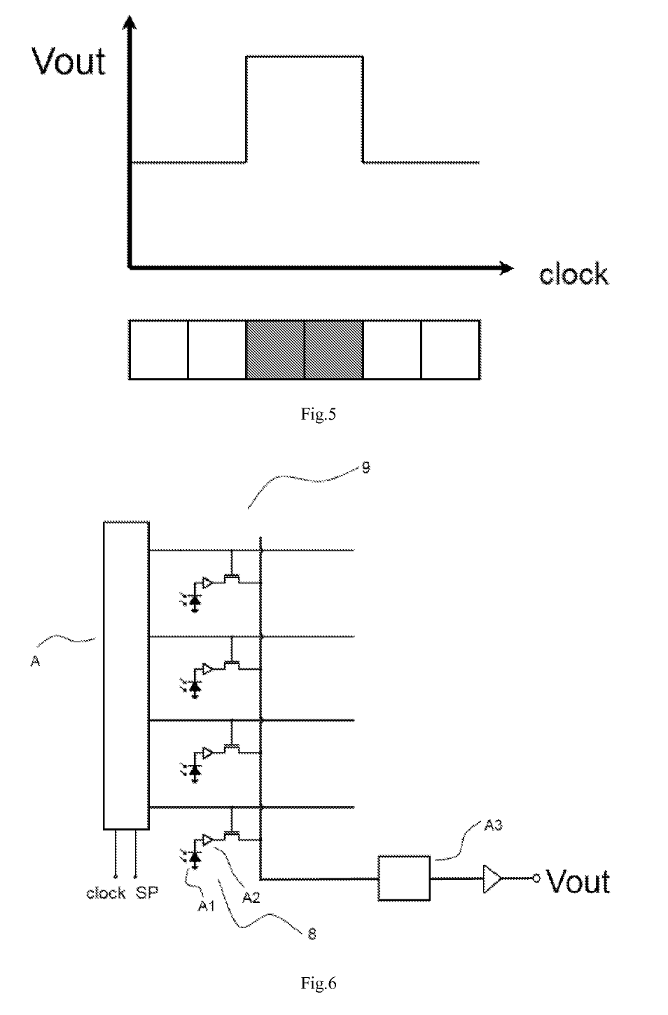

FIG. 4 illustrates the circuit of the present invention, which adopts the light detector 8 of the light communication technology as shown in FIG. 6. The light frequency detecting device 9 includes multiple light detectors 8 that mainly inputs a sequential clock signal (clock) to drive the light receiving and scanning circuit module A (i.e. a displacement temporary storing unit) and an initial pulse (SP) to determine whether a period is completed or not. When a photodiode Al receives a light wave signal, an electric current is generated, wherein the electric current is amplified by an amplifier A2 and then selectively outputs by the light receiving and scanning circuit module A. Therefore, the input clock signal of the light receiving and scanning circuit module A can provide the basic position information through the determination of whether there is signal generated via a filter A3. Referring to FIG. 5, as the device of the present invention only needs to determine whether there is a signal or not, the curve of the present invention is different from that of the conventional device. Hence, the curve of the present invention is hard to be affected by the fluctuation of the export curve to avoid determination mistakes. The touch device of the present invention uses a scanning counter to determine the position parameter of the object to be detected and then to determine the corresponding coordinate. FIG. 8 illustrates the signal acquiring of the circuit after receiving the light frequency.

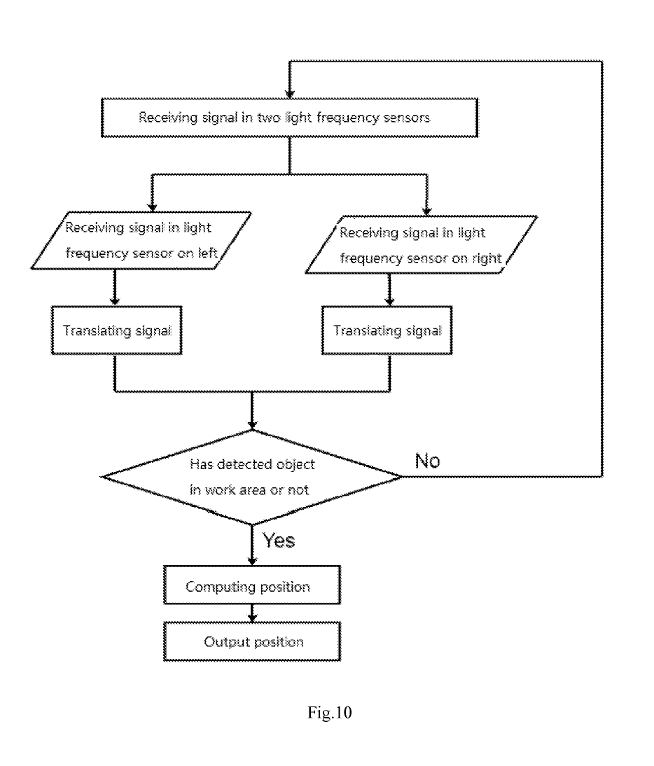

FIG. 10 illustrates a flow chart of the present invention. Firstly, receive the signals in the two light frequency sensors 3 and 4, which means the second light frequency sensor 4 arranged on the left and the first light frequency sensor 3 arranged on the right respectively receive and translate signals. And then determine whether the object to be detected is positioned in the working field 2 or not. If so, compute out the position of the object and output the position of the object. If not, return back and receive the signals in the two light frequency sensors 3 and 4 again.

Therefore, in order to resolve the problem of the noise of the light source, the emission light sources 6B and 6C have a pre-determined frequency. Additionally, the filter A3 is arranged in the light receiving and scanning electric circuit A of the present invention. As only the signal with pre-determined frequency is used to generate the determined position, the noise of the light source with different frequency could be filtered that achieves another object of the present invention.

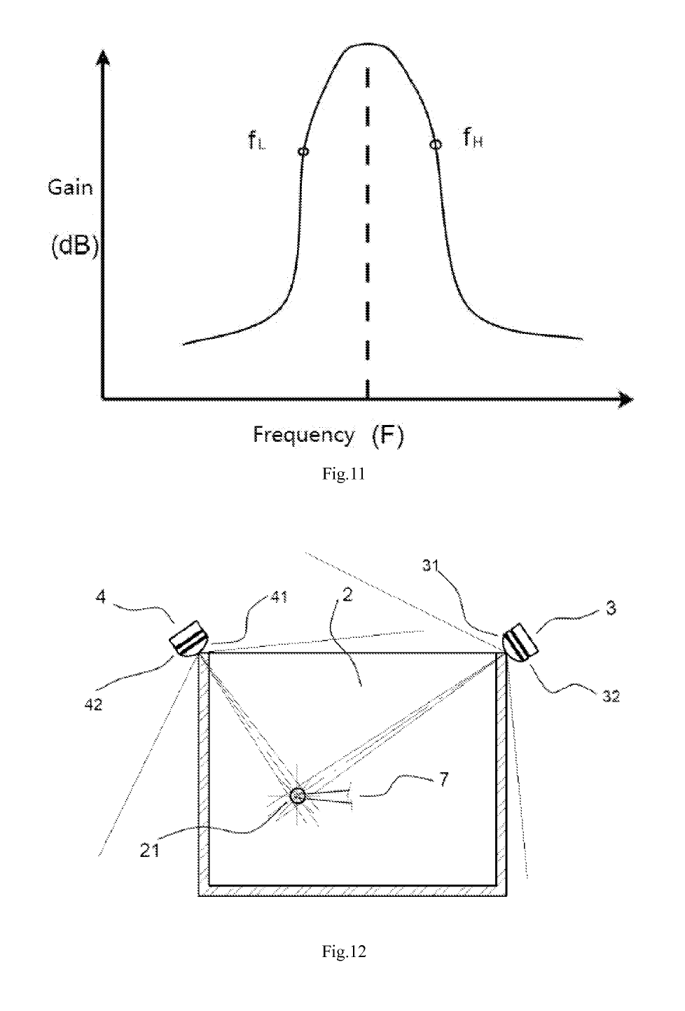

FIG. 11 illustrates the characteristic curve of the filter A3 of the present invention. Referring to FIG. 11, the gain of the pre-determined frequency is obvious, while the non-pre-determined frequency is attenuated. In the present invention, when the light frequency sensors 3, 4 receive a light source with a pre-determined frequency, the light frequency sensors 3, 4 will let this light source pass through, while that when the light frequency sensors 3, 4 receive a light source with non-pre-determined frequency, the light frequency sensors 3, 4 will attenuate this light source in order to filter the noise of the light source. That means an attenuate of a single light detector module will generate and output an electric current correspondingly. As the irradiation light source of the present invention provides a specified intermittent light irradiation instead of a continuous light irradiation, the electric current generated in the photodiode is output specified intermittently. Therefore, when this specified intermittently output electric current flows through the filter A3, the electric current is received in the filter A3 and then is output to generate a signal. As the environment light source is a continuous or limitless intermittent light irradiation instead of a specified intermittent light irradiation and the electric current generated in the photodiode of the single light detector module is specified intermittent, the photodiode is irradiated with the light to generate an electric current, which is transmitted out specified intermittently and is therefore filtered by the filter A3 to disable the electric current to generate the signal.

Referring to FIG. 12, another embodiment of the present invention is illustrated. In this embodiment, a light source with a specified frequency is used to provide an automatic proactive signal determination, which is opposite to the passive signal determination as shown in FIG. 9, wherein, for the proactive signal determination, a light source pen 7 provides a light source to mark the object to be detected 21 in the work area 2, and thus the insides of the other three sides other than the side of the first light frequency sensor 3 and the second light frequency sensor 4 aligned thereon do not need to provide the refracting sheet 22.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A touch device with a light frequency sensor for sensing a relative position of an object to be detected, comprising:
a work area;
a light source with specific frequency, which is arranged toward said work area;
at least two light frequency sensors respectively detecting a light frequency of a light entered into a lens and a filter thereof; and
a position computation module, which is linked with the two light frequency sensors for signal connection and detects characteristic data by means of trigonometry to determine a position of the object to be detected.

2. The touch device, as recited in claim 1, wherein said first light frequency sensor and said second light frequency sensor are aligned and respectively arranged at two angle corners of said work area while directly toward said work area, wherein each of said first light frequency sensor and said second light frequency sensor comprises a light receiving and scanning circuit module.

3. The touch device, as recited in claim 1, wherein said work area has a shape of quadrangle and each of said first light frequency sensor and said second light frequency sensor comprises a light source disposed on a side thereof and arranged toward said work area.

4. The touch device, as recited in claim 1, wherein said work area has a shape of quadrangle, wherein said touch device further comprises a light source pen providing a light source with a specific frequency to mark said object to be detected in said work area.

5. The touch device, as recited in claim 1, further comprising a filter disposed inside said light receiving and scanning circuit module, wherein said filter receives a signal with a specific frequency and filters a noise light with non-specific frequency.

6. The touch device, as recited in claim 1, further comprising multiple reflecting sheets respectively disposed on insides of three sides other than the side with said first light frequency sensor and said second light frequency sensor aligned thereon, wherein said reflecting sheets reflect light source which is not used for determining said position out off said work area to avoid generating unnecessary disturbance source.
